(19) United States
(12) Patent Application Publication
(10) Pub. No.: US 2005/0099650 A1
(43) Pub. Date: May 12, 2005

(54) Web page printer

(76) Inventors: Mark Louis Brown, Boise, ID (US); Vincent C. Skurdal, Boise, ID (US); Marvin Duane Nelson, Meridian, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/702,833

(22) Filed: Nov. 6, 2003

(51) Int. Cl. G06F 15/00; H04N 1/00

(52) U.S. Cl. 358/1.15; 358/402

(57) ABSTRACT

One aspect of the present invention is directed to a printer comprising a printing mechanism, a memory, and a user interface. The memory is configured to store a uniform resource locator address. The user interface is configured to permit activation of the uniform resource locator address from the memory to retrieve, independent of a separate computing device, a first web page from the uniform resource locator address and to print the first web page via printing mechanism.

### BACKGROUND OF THE INVENTION

The World Wide Web has catapulted forward the information age. Through the use of a personal computer and a printer, people can readily obtain a printed copy of virtually any publication. To do so, the user employs a web browser on a personal computer to identify a publication appearing as a web page on a web site, and then prints the publication by sending a print command from the personal computer to the printer connected to the computer.

While this routine is a convenient way to obtain a copy of a publication, this process can be rather arduous when repeated many times, over many days to obtain the same publication. Accordingly, people waste unnecessary time using a personal computer to repeat the same keystrokes and maneuvers with their pointing device (e.g., mouse and/or keyboard) to activate a link to request the publication, and then repeat another set of well rehearsed keystrokes (or clicks of a mouse) to activate the connected printer to print the publication.

### SUMMARY OF THE INVENTION

One aspect of the present invention is directed to a printer comprising a printing mechanism, a memory, and a user interface. The memory is configured to store a uniform resource locator address. The user interface is configured to permit activation of the uniform resource locator address from the memory to retrieve, independent of a computing device, a first web page from the uniform resource locator address and to print the first web page with the printing mechanism.

### BRIEF DESCRIPTION OF THE DRAWINGS

FIG. 1 is a perspective view of web page printer, according to an embodiment of the present invention.

FIG. 2 is block diagram of a web page printing system, according to an embodiment of the present invention.

FIG. 3 is a flow diagram of a method of web page printing, according to an embodiment of the present invention.

FIG. 4 is a block diagram of a web page printer manager, according to an embodiment of the present invention.

FIG. 5 is a perspective view of a method of printing a web page, according to an embodiment of the present invention.

FIG. 6 is a flow diagram of a method of web page, according to an embodiment of the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims. All such variations are within the scope of the present invention.

Embodiments of the present invention are directed to a printer configured for printing web pages that greatly enhances obtaining printed publications from the Internet. In one aspect of a method of printing web pages, the user only needs to press a one-touch print button of a multifunction printer to activate the retrieval of a web page and to print that web page on the multifunction printer. In a more detailed aspect of the method, a user selectively identifies multiple uniform resource locator addresses and then assigns each uniform resource locator address to its own corresponding one-touch print button of the printer. Users are saved from having to use a computer connected to the printer to execute a series of keystrokes or mouse maneuvers to select a uniform resource locator (URL) address, retrieve the web page at the URL address, and request printing of the web page. Instead, a single press of a one-touch print button of the printer activates both retrieval and printing of the web page.

Components of the present invention may be implemented in hardware via a microprocessor, programmable logic, or state machine, in firmware, or in software within a given device. In one aspect, at least a portion of the software programming is web-based and written in HTML and JAVA programming languages, including links to graphical user interfaces, such as via windows-based operating system. The components may communicate via a network using a communication bus protocol. For example, the present invention may or may not use a TCP/IP protocol suite for data transport. Other programming languages and communication bus protocols suitable for use with the present invention will become apparent to those skilled in the art after reading the present application. Components of the present invention may reside in software on one or more computer-readable media. The term computer-readable media as used herein is defined to include any kind of memory, volatile or non-volatile, such as floppy disks, hard disks, CD-ROMs, flash memory, read-only memory (ROM), and random access memory (RAM).

Preferably, the user interfaces, such as a web browser, described herein run on a controller, computer, appliance or other device having an operating system which can support one or more applications. The operating system is stored in memory and executes on a processor. The operating system is preferably a multi-tasking operating system which allows simultaneous execution of multiple applications, although aspects of this invention may be implemented using a single-tasking operating system. The operating system employs a graphical user interface windowing environment which presents the applications or documents in specially delineated areas of the display screen called “windows.” The operating system preferably includes a windows-based dynamic display which allows for the entry or selection of data in dynamic data field locations via an input device such as a keyboard and/or mouse. One preferred operating system is a Windows® brand operating system sold by Microsoft Corporation. In another embodiment, the operating system does not employ a windowing environment. However, other operating systems which provide windowing environments may be employed, such as Unix, Linux, and other platforms capable of executing web browser software that provides HTTP (Hyper Text Transfer Protocol) client functions and that renders HTML (Hyper Text Markup Language) files.

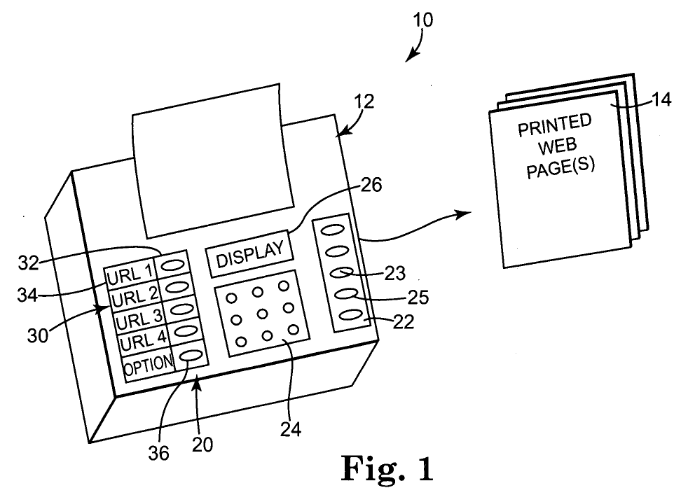

In one exemplary embodiment of the present invention shown in FIG. 1, system 10 includes multifunction printer 12 with Web pages 14 printed from printer 12. Multifunction printer 12 comprises user interface 20, which includes control panel 22, keypad 24, display 26, and web page print panel 30. Control panel 22 includes optional print link button 23 and/or address book print function 25. Web page print panel 30 includes one-touch print button(s) 32, web page link labels 34, and option function button 36. Accordingly, printer 12 has only the function of printing (i.e., a printing mechanism) without the functions of facsimile, copying, and/or scanning, or printer 12 optionally has any or all of these functions in one device.

With user interface 20 of multifunction printer 12, a user may directly request and print a web page 14 directly from multifunction printer 12. In particulars a user may press any one-touch print button 32 of web page print panel 30 to request printing of a web page corresponding to a web page link identified in web page link label 34. Upon pressing of the one-touch print button 32, multifunction printer 12 directly (or indirectly through a computing device) retrieves the requested web pages from the World Wide Web, and prints those pages through printer 12 as printed web page 14.

Alternatively, a user can press address-book print function 25 to retrieve an address book (e.g., indexed list of URL addresses, etc.) from memory to access stored URLs through alphanumeric indexing. In particular, pressing address book print function 25 and then entering an alphanumeric identifier (e.g., letter(s) and/or numbers) on keypad 24 that corresponds to a stored URL in the address book, triggers retrieval of the selected URL and printing of its corresponding web page. For example, a user would retrieve and print a web page from an URL associated with address book entry 53 by pressing the address book print function 25, followed by pressing the numerals 5 and 3, and then enter on key pad 24. Accordingly, with printer 12, the user can activate a address book print function 25 to facilitate a minimal entry of only one, two or three keys to retrieve the much longer URL (e.g. commonly, 8 to 16 digits), thereby saving a user from entering a lengthy URL to access its corresponding web page. Accordingly, whether using one-touch print buttons 32 or address-book print function 25, a user is able to use a reduced keystroke method to retrieve and print a web page with printer 12.

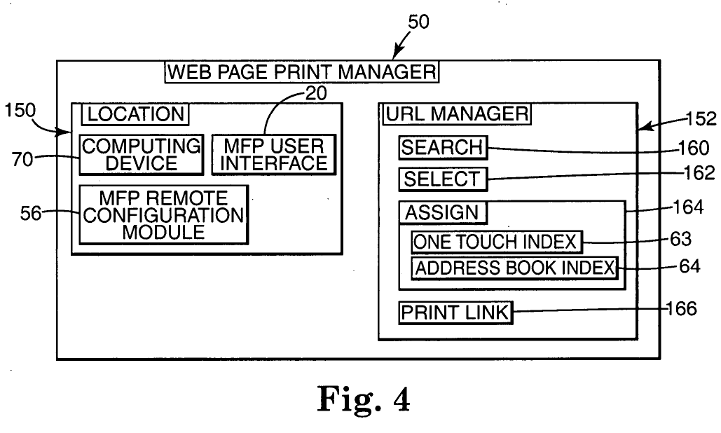

Print link function 23 and options link button 36 of control panel 22 will be described later in association with FIGS. 4-6. Control panel 22 also is optionally arranged to incorporate web page print panel 30, including an array of one-touch print buttons 32.

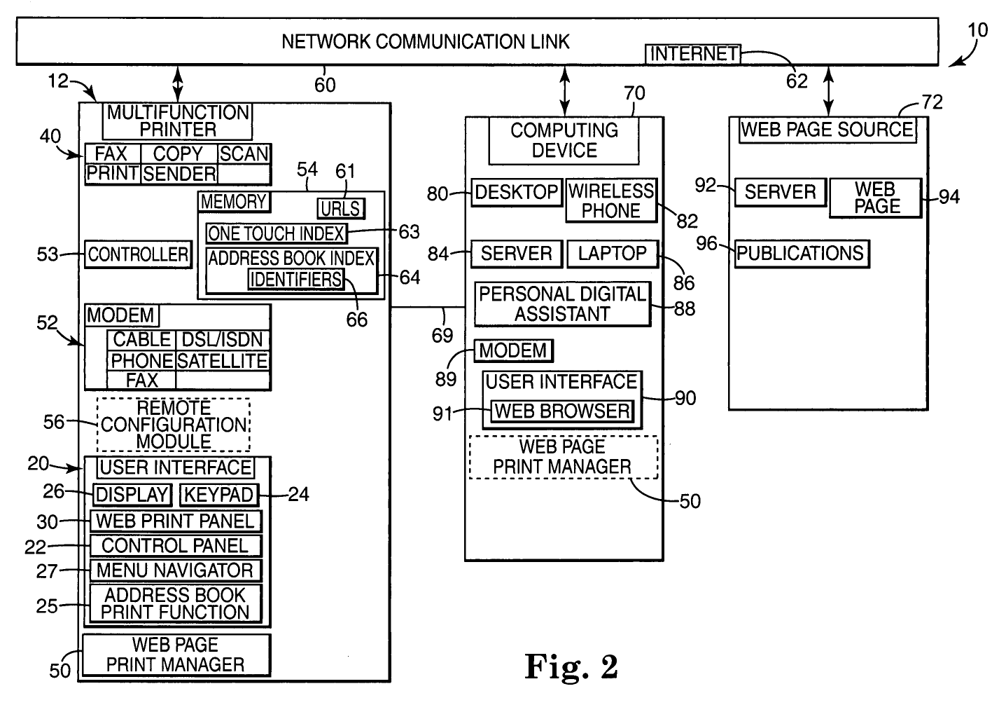

As shown in FIG. 2, in addition to multifunction printer 12, system 10 further comprises computing device 70, network communication link 60 and web page source 72. Multifunction printer 12 comprises user interface 20, device functions 40, web page print manager 50, modem 52, controller 53, memory 54, and remote configuration module 56. Device functions 40 specify any one (or all) of the functions incorporated in, and/or available through, multifunction printer 12 including: facsimile; copying; scanning; printing; and/or digital sending.

Control panel 22, keypad 24, and web page print panel 30 of user interface 20 control the functions of printer 12 while display 26 supports a graphical user interface for viewing menu-driven selected functions of multifunction printer 12. Keypad 24 includes an alphanumeric keypad for dialing telephone numbers, entering email addresses, and URL addresses, etc. Control panel 22 preferably includes functions for generally controlling multifunction printers such as start printing, stop printing, activate facsimile function, activate copy function, and activate scan function. Menu navigator 27, in cooperation with display 26, facilitates operation of multifunction printer 12. Menu navigator 27 preferably includes an array of buttons including a menu button, multiple cursor/directional keys, and also optionally comprises a touchscreen capability integrated with the display 26.

Modem 52 of multifunction printer 12 includes at least one of a cable modem, phone modem, fax modem (programmable), distributed service line (DSL) modem or integrated service distribution network (ISDN) modem, and satellite modem. Modem 52 is incorporated directly in printer 12 and/or implemented indirectly as a network resource, in communication with and accessible by printer 12, such as through a 10/100 bt connection. Modem 52 enables printer 12 to communicate with other entities such as computing device 70 or web page source 72. Moreover, modem 52 with controller 53 (described below) enables printer 12 to be web-capable so that printer 12 can communicate, independent of computing device 70, with Internet entities such as web sites and web page sources 72.

Web page print panel 30 of user interface 20 carries the features described in association with FIG. 1, allowing one-touch activation of one-touch print buttons 32 to request and activate printing of a designated web page. Web page print panel 30 is further described later in association FIG. 4. Web page print manager 50 supports Web page print panel 30 to facilitate identifying, selecting, and assigning a web page link to a particular one-touch print button 32 on web page print panel 30 of multifunction printer 12, or managing address book print function 25.

Controller 53 of multifunction printer 12 supports all functions of multifunction printer 12, and preferably includes hardware, software, firmware or combination of these. In one preferred embodiment, controller 53 includes a microprocessor-based system capable of performing a sequence and logic operation and including memory for storing information. Controller 53 also supports modem 52 and/or Web page print manager 50 with user interface 20 so that multifunction printer 12 is Web-savvy, capable of obtaining web pages from the World Wide Web, with or without assistance from computing device 70, for printing on multifunction printer 12. In-particular, memory 54 of multifunction printer 12 enables storage of web pages, web page links, as well as storage of images of printed pages scanned by multifunction printer 12.

Memory 54 stores an array 61 of uniform resource locator addresses, one-touch index 63, and address book index 64. One-touch index 63 is linked to URL address array 61 and includes an index specifying a unique one-touch print button 32 (from a plurality of one-touch print buttons 32 from web page print panel 30 of user interface 20) for each URL address in array 61. Address book index 64 is linked to URL address array 61 and includes a unique alphanumeric identifier 66 for each URL address in array 61. Memory 54 may be backed up by a battery, uninterruptible power supply, or implemented as a memory unit having permanence (e.g., hard drive, programmable read only memory, etc) so that memory 54 maintains stored URLs through power cycles.

Remote configuration module 56 of multifunction printer 12 is optionally included to enable remote configuration of multifunction printer 12 and in particular, electronic access to user interface 20 and/or Web page print manager 50 via computing device 70 located remotely from printer 12. Remote configuration module 56 is preferably implemented through dedicated control languages, such as Printer Job Language (i.e., PJL) and/or Printer Management Language (i.e., PML), as well as optionally through an embedded web server, such as those disclosed in U.S. Pat. Nos. 5,596,487, and 6,107,007, which are hereby expressly incorporated by reference.

Computing device 70 optionally is used to operate printer 12 to send files to printer 12 for printing, and to optionally enable an Internet connection or communication between printer 12 and web page source 72 for retrieving web page 14, 94 to be printed at printer 12. Computing device 70 is embodied in at least one of a desktop computer 80, wireless phone 82, server 84, portable computer 86, and personal digital assistant 88. Computing device 70 further comprises modem 89 for network communication (via network communication link 60) with the web page source 72, and includes substantially the same features and attributes as modem 52 of multifunction printer 12. However, modem 89 and modem 52 need not be implemented identically.

Computing device 70 also comprises optional web page print manager 50 for optionally using computing device 70, instead of printer 12, to uniquely assign a separate web page link to each of one-touch print buttons 32 on web page print panel 30 of printer 12. User interface 90 of computing device 70 permits operation of computing device 70 and control of multifunction printer 12, and includes Web browser 91 to permit navigation of the World Wide Web for accessing web page resources 72 and for accessing remote configuration module 56 of multifunction printer 12.

Web page source 72 comprises server 92, web page 94, and publications 96. Web page source 72 represents any web sites or portal that makes available web pages 94 (e.g. HTML files, XML files, etc.) for viewing on a Web browser of computing device 70 and/or printing at printer 12. Server 92 supports the publication and management of web pages 94 on the World Wide Web. Publication 96 comprises any one of a plurality of publications available from a Web site as web pages 94, such as the New York Times, crossword puzzles, Time magazine, Wall Street Journal, maps, weather reports, etc. A web page link is any word(s) and/or symbols that represent a web page so that upon activation of the web page link, a URL address corresponding to the web page is used to access the web page. Accordingly, words and/or symbols comprising the web page link include the URL address, a portion of the URL address, a merely symbolic representation of the contents of the web page, and/or a non-substantive attractant (e.g. advertisement) to the web page. Finally, web page source 72 includes a web page source address, commonly known as a uniform resource locator address.

Network communication link 60, as used herein, includes an internet communication link (e.g., the Internet), an intranet communication link, or similar high-speed communication link. In one preferred embodiment, network communication link 60 includes an Internet communication link 62. Internet communication link 62 permits communication between multifunction printer 12, computing device 70 and web page source 72. However, multifunction printer 12 can be connected directly to computing device 70 via direct communication link 69.

Accordingly, multifunction printer 12 prints Web pages 14, 94 from web page source 72 via activation of one-touch print buttons 32 on Web page print panel 30 of multifunction printer 12, with access to web page sources 72 made directly from multifunction printer 12, or made indirectly for printer 12 via computing device 70. Of course, address book print function 25 also can be used as a speed dial printing mechanism, permitting fast retrieval and printing of web page 14, 94 by a single key activation of address book print function 25 along with one, two or three key alphanumeric keystrokes to specify an alphanumeric identifier to activate a much longer URL address stored in memory 54.

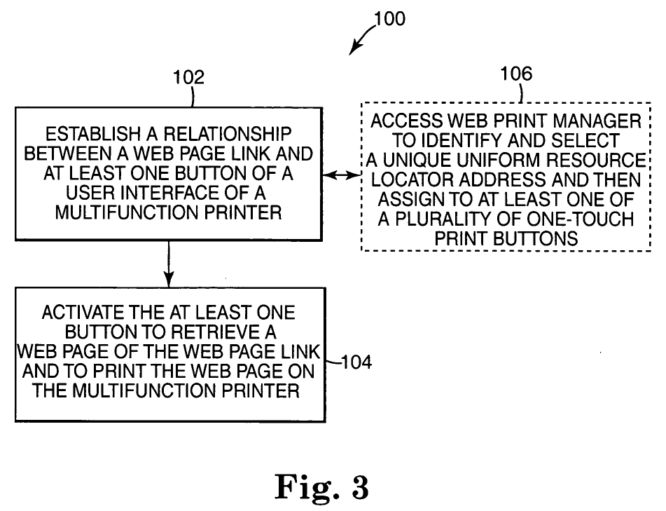

A method 100 of the present invention for printing web pages is shown in FIG. 3. As shown in box 102, multifunction printer 12 is used in method 100 to establish a relationship between a web page link (e.g., a URL address) and at least one button of user interface 20 of multifunction printer 12. The at least one button preferably is a one-touch print button 32 of a plurality of one-touch print buttons 32 of web page print panel 30 of user interface 20. However, this button also can be supplied by one button of control panel 22 such as print link button 23, or the speed dial use of address book print function 25 including one or more alphanumeric keystrokes to specify an alphanumeric identifier for a stored URL address. The relationship between a one-touch print button 32 and web page 94 to be printed from a web page link is created using user interface 20 of printer 12, or user interface 90 of computing device 70. Remote configuration module 56 of multifunction printer 12 also is optionally employed (with either user interface 20 or user interface 90) to create the relationship between the one-touch print button 32 and a unique web page link.

Via one of these user interfaces 20, 90, the user accesses the World Wide Web to specify that a particular URL address corresponds to the desired web page to be printed. For each one-touch print button 32, the user designates a one to one correspondence between a particular one-touch button and a selected web page link (e.g., a URL address). The designated web page links are listed on web page link labels 34 of web page print panel 30.

As shown in box 166, web page print manager 50 is also optionally used in method 100 to assign web page links by identifying and selecting a plurality of unique URL addresses and then assigning each unique URL address to one of a plurality of one-touch buttons of web page print panel 30 or to one of the alphanumeric identifiers stored in memory 54 and used in association with address book print function 25.

Next, as shown in box 104, a user activates the at least one button of the user interface 20 (e.g. one of one-touch print buttons 32) in method 100 with a single touch to retrieve a web page 94 from web page source 72 (via an URL address) and to print web page 94 on multifunction printer 12.

Web page print manager 50 facilitates retrieval and printing of web pages and specifically supports programming and control of web page print panel 30 of user interface 20 for printer 12. As shown in FIG. 4, web page print manager 50 comprises location designator 150 and uniform resource locator (URL) manager 152. Location designator 150 governs access to web page print manager 50 in any one or all of the following locations including user interface 90 of computing device 70, user interface 20 of multifunction printer 12, and/or through remote configuration module 56 of multifunction printer 12.

URL manager 152 of web page print manager 50 manages retrieval and printing of web pages and comprises search function 160, select function 162, assign function 164, and print link function 166. Search function 160 permits a user to perform a keyword search for a desired web page and/or URL address. Select function 162 permits the user to select a web page link (e.g., URL address) for retrieval from a plurality of web page links (e.g., URL addresses) that are stored in memory 54 or found in a search. Assign function 164 enables a user to assign a URL address to a particular one-touch print button 32 on Web page print panel 30 or to a particular alphanumeric identifier accessible through address book print function 25 and key pad 24. Assign function 164 is used to create, modify, or delete entries from one-touch print index 63 and/or address book index 64 in memory 54. Finally, print link function 166 enables a user to activate printing a web page on the multifunction printer 12 using an alternative button on multifunction printer 12, such as print link button 23 of control panel 22 or options function link 36 on web page print panel 30.

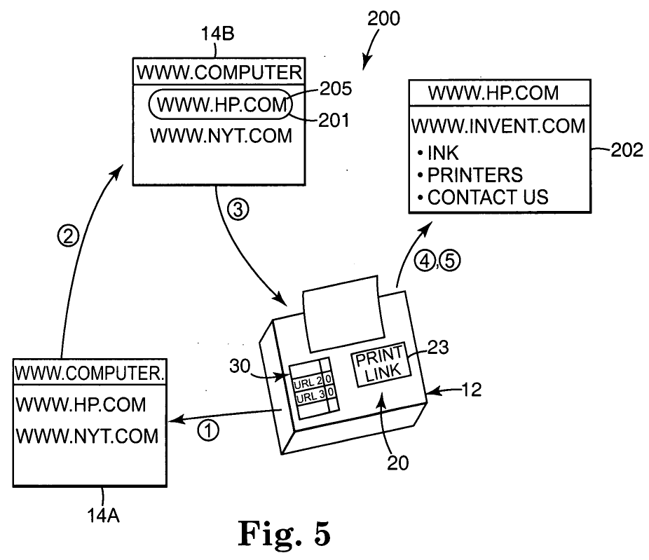

In another exemplary embodiment of a method 200 of the present invention, the method 200 enables using multifunction printer 12 to electronically capture a web page link (or URL address) from a printed page and then use that electronically captured web page link (or URL address) to retrieve and print the web page corresponding to the electronically captured web page link (or URL address). FIG. 5 is a schematic illustration of a method 200 of the present invention of electronically capturing a web page link from a printed page using multifunction printer 12. As shown in FIG. 5, multifunction printer 12 includes web page print panel 30, which includes substantially the same attributes and features as described for multifunction printer 12 in association with FIGS. 1-4. In addition, for illustrative purposes, print link function 23 of control panel 22 is shown. Print link function 23 permits multifunction printer 12 to print a web page 202 based on a marked web page link from a scanned page, without having to assign the web page link to one of the one-touch print buttons 32 of web page print panel 30 or to one of the alphanumeric identifiers of address book index 64.

In this system and method, as shown by label 1, printer 12 prints web page 14A from an URL address, such as www.computer.com. The resulting web page 14A, when printed, includes additional links such as www.HP.com and www.NYT.com, as well as other links. Next, as shown by label 2, the user uses a marker or other indicia 201 to mark one of the printed web page links, such as www.HP.com, to result in a marked web page 14B, specifically including a marked web page link 205. As shown by label 3, the marked web page 14B is fed into multifunction printer 12 for scanning.

Next, the user activates print link function button 23 of control panel 22, which commands scanning of marked web page 14B, retrieval of the marked web page link (e.g.,www.HP.com) via modem 52 (or via network communication link 60) and controller 53 of multifunction printer 12, and printing of that web page on printer 12. Scanning includes obtaining an image of the marked page (e.g. a bitmap) and then comparing that image with an image of the original page, prior to marking, as printed by printer 12 to determine which web page link is to be retrieved.

This method also optionally can be performed where marked web page 14B is scanned before activating print link function 23. To do so, multifunction printer 12 scans marked web page 14B, recognizes indicia 201 on marked web page and then makes that marked web page link (e.g., www.HP.com) available through user interface 20 and/or web page print panel 30 as a selectable web page that is printable through activation of print link function 23. Then, upon activating print link function 23 for web page link www.HP.com, multifunction printer 12 retrieves web page 202 and prints web page 202 of web page link www.HP.com.

In each of these systems and methods, when scanning to capture web page links from a printed page, web page link preferable comprises an actual URL or memory 54 of printer 12 has an electronic representation of the printed web page so that the actual URL corresponding to a symbolic web page link is accessible for retrieval of the web page from the web page link.

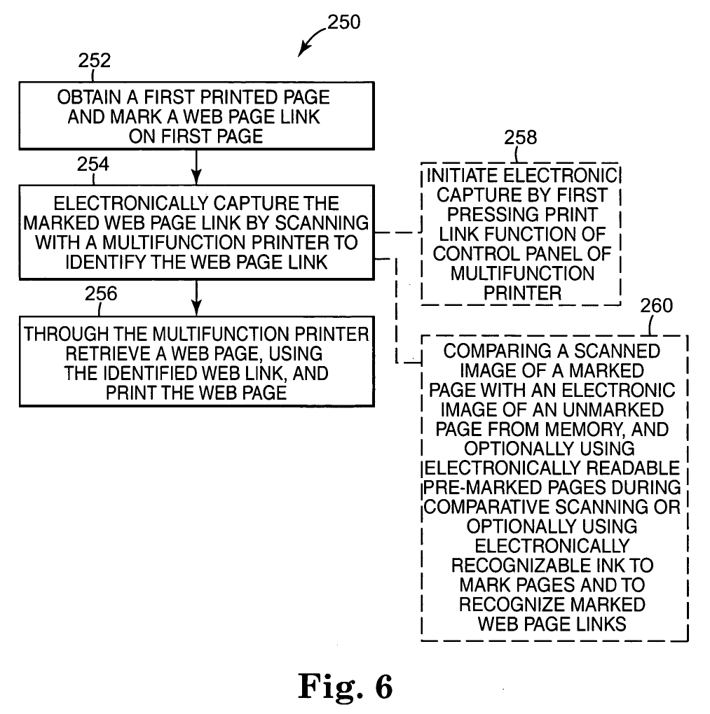

As shown in FIG. 6, method 250 of the present invention for printing web pages includes electronically capturing web page links from printed pages and then printing the web page based on the captured web page link. As shown by box 252, a user obtains a first printed page, which is preferably a web page, and marks a web page link on the first printed page. However, the first printed page optionally can be any printed page or even a handwritten page that includes a web page link (e.g., URL address) that is recognizable by an optical character recognition (OCR) algorithm of a scanner.

Next, as shown by box 254, the marked web page link is electronically captured to identify a selected web page link on the first printed page. The electronic capture is preferably performed by scanning the marked first printed page using multifunction printer 12. Through the use of the scanner, the web page link contained within the marking is identified as corresponding to a web page that is to be retrieved (and/or stored in memory) for association with a one-touch print button 32 of multifunction printer 12.

As shown by box 256, multifunction printer 12 then retrieves a web page using the identified web page link on first printed page and then prints the web page on multifunction printer 12.

Method 250 is also optionally initiated by first feeding the printed page to multifunction printer 12 for scanning, and then pressing print link function 23 to request scanning of the printed page by multifunction printer 12, and then retrieval and printing of the desired web page through multifunction printer 12, preferably independent of computing device 70.

As shown in box 260, this method 250 also optionally includes use of pre-marked pages so that each page scanned or printed by printer 12 is uniquely identifiable. For example, each pre-marked page can include a bar code or other machine readable indicia to uniquely identify each page. These pre-marked pages would ease burden on printer 12 of recognizing pages that have been printed in the past by printer 12. Each page already printed or scanned by printer 12 that includes these indicia would be stored as an image in memory 54. Accordingly, when a marked web page link is desired to be accessed from a printed page using method 250 and that printed page was previously scanned into printer 12, printer 12 can retrieve an electronic image of that printed page (including supporting HTML commands). Through the use of the pre-marked pages, printer 12 can more easily compare an image of the scanned page (e.g. bitmap) with an image of a previously printed page (e.g., a bitmap stored in memory or retrieved from web using web page link) or previously scanned page to identify the marked area of page and the correct uniform resource locator address of the web page link.

In addition, this method 250 also can be executed in cases in which the first printed page to be scanned was not produced from multifunction printer 12. In other words, a user can obtain a printed page from any printer, mark a desired web page link on that printed web page, and then use print link function 23 of multifunction printer 12 to retrieve and print the web-page represented by the web page link. In particular, a printed page is fed into multifunction printer 12 and then print link function 23 is activated, which initiates scanning the marked printed page to electronically capture the marked web page link, and then retrieve and print the web page.

When identifying web page links from pages not previously scanned or printed from printer 12, this method 250 (as shown in box 260) optionally includes using an ink that is electronically recognizable by scanner to mark the web page link. For example, electronically recognizable inks for use in this method include, but are not limited to: ultraviolet inks; fluorescent inks; infrared inks; metallic inks; and inks having a specific color not on the printed page, etc. Accordingly, upon scanning, printer 12 readily recognizes web page link identified by the marking. This ink marking obviates the need for comparison of the marked page with a previously scanned unmarked page.

This system and method of the present invention enables simple retrieval of and printing of a web page directly from a printer, preferably independent of a computing device. In addition, identification of a web page to be retrieved can be made through marking the web page link on a printed page and then scanning the marked page to identify the desired link, and then using the identified web page link to retrieve the desired web page and print it on multifunction printer 12.

While specific embodiments have been illustrated and described, herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the chemical, mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

1. A printer comprising:
a printing mechanism;
a memory configured to store a uniform resource locator address; and
a user interface configured to permit activation of the uniform resource locator address from the memory to retrieve, independent of a separate computing device, a first web page from the uniform resource locator address and to print the first web page via the printing mechanism.

2. The printer of claim 1 and further comprising:
a controller; and
a modem in communication with the controller and configured for retrieving the first web page via an internet communication through at least one of a satellite Internet line modem, a distributed services line modem, a telephone modem, a cable modem, and an integrated services distribution network modem.

3. The printer of claim 1 wherein the memory comprises
an array of uniform resource locator addresses with each address corresponding to a unique alphanumeric identifier so that upon activation of a address book print function of the user interface and upon entry of one of the alphanumeric identifiers, the user interface uses the uniform resource locator address corresponding to the alphanumeric identifier to retrieve the web page of the uniform resource locator address.

4. The printer of claim 1 wherein the user interface comprises:
an array of one-touch print buttons with each one-touch button being programmed to correspond to a unique uniform resource locator address so that upon activation of the one-touch print button, the printer retrieves the web page from the corresponding uniform resource locator address.

5. The printer of claim 4 wherein the user interface comprises:
an index of web page link labels with each web page link labels corresponding to one of the one-touch print buttons and configured to activate retrieval and printing of the web page corresponding to the web page link label representing the web page.

6. The printer of claim 1 wherein the printer further comprises a multifunction printer including at least one of a facsimile component, a scanning component, and a copier component.

7. The printer of claim 1 and further comprising a system including:
a computing device separate from the printer and configured for communicating with the Internet and comprising at least one of a desktop computer, a server, a personal digital assistant, a wireless mobile phone, and a notebook computer;
a web page source; and
a network communication link,
wherein the printer is capable of communication with the computing device and with the web page source through the network communication link to retrieve the first web page, and the printer is configured to print the first web page from the web page source.

8. The printer of claim 1 and further comprising a system including:
the computing device in communication with the printer wherein the printer comprises a remote configuration module configured for access by the computing device to control, remotely via the computing device, the user interface of the printer to retrieve the web page.

9. A method of printing web pages, the method comprising:
assigning at least one control panel button of an array of control panel buttons of a printer to correspond to a first web page; and
activating the at least one control panel button of the array of control panel buttons to retrieve the, first web page from a web page source, via an internet communication performed by the printer, and to print the first web page on the printer.

10. The method of claim 9 wherein activating the at least one control panel button comprises:
retrieving the first web page from the web page source via the printer exclusively.

11. The method of claim 9 wherein activating the at least one control panel button comprises:
retrieving the first web page from the web page source via a network communication link and a computing device in communication with the printer.

12. The method of claim 9 and further comprising:
marking, on the first web page, a first web page link corresponding to a second web page; and
activating a second control panel button of the array of control panel buttons of the printer to:
scan the first web page in the printer to electronically capture the marked first web page link;
retrieve the second web page corresponding to the marked first web page link; and
print the second web page.

13. The method of claim 12 wherein activating the second control panel button to scan the first web page further comprises:
comparing an image of the scanned first web page with a stored image of the first web page to identify an area of the first web page that includes the marked first web page link;
selecting, from the stored first web page, a web page link that is closest in proximity to the marked first web page link; and
associating the selected web page link with the second control panel button of the plurality of control panel buttons for activation to retrieve the second web page and to print the second web page.

14. A method of printing a web page comprising:
associating a first control panel button of a plurality of control panel buttons of a multifunction printer with a first web page;
activating only the first control panel button of the plurality of control panel buttons to retrieve the first web page and to print the first web page on the multifunction printer;
marking a first web page link on the first web page;
electronically capturing, via the multifunction printer, the marked first web page link from the first web page; and
activating a second control panel button of the plurality of control panel buttons to retrieve a second web page corresponding to the first web page link, via an internet communication performed by the multifunction printer, and to print the second web page on the multifunction printer.

15. The method of claim 14 wherein electronically capturing the marked first page comprises:
scanning the printed first web page; and
optically recognizing the marked first web page link from the scanned image of the printed first web page.

16. The method of claim 14 wherein activating the second control panel button comprises performing the internet communication via a computing device that is separate from the multifunction printer and that is in communication with the multifunction printer.

17. A method of printing a web page comprising:
marking a web page link on a first page;
electronically capturing, via a multifunction printer, the marked web page link from the first page; and
retrieving, via the multifunction printer, a web page corresponding to the web page link; and
printing the web page on the multifunction printer.

18. The method of claim 17 wherein electronically capturing the marked web page link comprises:
one-touch activating a first button of a control panel of the multifunction printer to initiate scanning the web page, retrieving the web page, and printing the web page.

19. The method of claim 17 wherein retrieving the web page comprises accessing a web page source via an internet communication performed exclusively by the multifunction printer.

20. A printer comprising:
means for printing documents;
means, independent of a computing device separate from the printer, for storing a web page source address; and
means, independent of the computing device separate from the printer, for user-initiated, one-step retrieval of a first web page using the web page source address and for initiating printing of the first web page via the means for printing documents.

21. The printer of claim 20 wherein the means for storing a web page source address comprises a memory of the printer and wherein the means for printing documents comprises a printing mechanism.

22. The printer of claim 20 wherein the means for user-initiated, one-step retrieval comprises:
a user interface comprising an array of control panel buttons including at least one button configured for performing the one-step user initiated retrieval of the first web page; and
a controller in communication with the user interface and configured to direct an internet communication to be performed exclusively by the printer to obtain the first web page and to direct activation of the means for printing documents.

23. A computer-readable medium having computer-executable instructions for performing a method of managing web page links, the method comprising:
managing at least one of:
a search function configured to execute keyword searches for web page links;
a select function configured to select a web page link from a plurality of web page links;
an assign function configured to assign a selected web page link to at least one of a one-touch print button and an alphanumeric identifier of an address book print function; and
a print link function configured to print a web page from a web page link that is selectively assigned to correspond to a print link button.

24. The medium of claim 23 wherein the method further comprises specifying at least one of the following locations, for managing printing web pages, including:
a computing device separate from the multifunction printer;
an user interface of a multifunction printer; and
a remote configuration module of a multifunction printer.
